(19) United States
(12) Patent Application Publication
(10) Pub. No.: US 2019/0050812 A1
(43) Pub. Date: Feb. 14, 2019

(54) PROJECT MANAGEMENT AND ACTIVITY TRACKING METHODS AND SYSTEMS

(71) Applicant: MARIO BOILEAU, BOURGET (CA)

(72) Inventor: MARIO BOILEAU, BOURGET (CA)

(21) Appl. No.: 16/059,392

(22) Filed: Aug. 9, 2018

Related U.S. Application Data
(60) Provisional application No. 62/542,953, filed on Aug. 9, 2017.

(51) Int. Cl. G06Q 10/10; G06F 3/0482; G06F 3/0484; G06Q 10/06

(52) U.S. Cl. CPC G06Q 10/103; G06Q 10/063114; G06F 3/0484; G06F 3/0482

(57) ABSTRACT

Within project management the tracking of actions for project meetings is undertaken through templates within standard office productivity tools which in common with dedicated meeting minute software and meeting software tools stand independent of project management software tools and manufacturing resource planning tools. The result is that users typically have actions arising from multiple projects each of which have multiple discrete and separate meetings occurring at different frequencies such that they must access a variety of documents in different tools to track meetings, actions given, action status etc. Accordingly, it would be beneficial to provide enterprises and users with a meeting management/action tracking software tool that supports interfaces with project management tools, manufacturing resource planning tools, customer management tools etc. so that they can obtain a centralized perspective of their actions across multiple projects and access real time information within meetings.

### CROSS-REFERENCE TO RELATED APPLICATIONS

This patent application claims the benefit of U.S. Provisional Patent Application U.S. 62/542,953 filed Aug. 9, 2017 entitled “Project Management and Activity Tracking Methods and Systems”, the entire contents of which are herein incorporated by reference.

### FIELD OF THE INVENTION

This invention relates to project management and activity tracking and more particularly to methods and systems providing users with improved visualization and management interfaces for activity tracking, project meetings, and project management.

### BACKGROUND OF THE INVENTION

Project Management is the process and activity of planning, organizing, motivating, and controlling resources, procedures and protocols to achieve specific goals. A project established through project management is designed to produce a unique product, service or result with a defined beginning and end (usually time-constrained, and often constrained by funding or deliverables), undertaken to meet unique goals and objectives, typically to bring about beneficial change or added value. Generally projects are temporary in nature in contrast with business as usual (or operations) of an enterprise that are repetitive, permanent, or semi-permanent functional activities to produce products or services. Amongst such operations is manufacturing and its associated Manufacturing Resource Planning (MRP) which are methods for effective planning of resources of a manufacturing enterprise and address operational planning in units, financial planning, and generally have a simulation capability to answer “what-if” questions. In practice, the management of these two aspects of the same enterprise is often quite different, and as such requires the development of distinct technical skills and management strategies directed to each.

A primary challenge of project management is to achieve all of the project goals and objectives while honoring the preconceived constraints which may include scope, time, quality and budget. A secondary challenge is to optimize the allocation of necessary inputs and integrate them to meet pre-defined objectives. Accordingly, project planning typically employs the use of schedules such as Gantt charts to plan and subsequently report progress within a project environment. Such project schedules are typically reviewed and discussed in project meetings which form just one type of ad-hoc or regular meeting project members attend as part of their activities. However, whilst there are a wide range of project management software tools (Project Management Tools—PMTs) to help users to create, manage, and visualize the logical dependencies between tasks as well as organize workloads, manage teams and individuals, establish the critical path, and track progress to completion of the objective the same is not true for tracking meetings, actions given, action status etc. nor providing a single user with a clear view of their actions arising from multiple projects with multiple discrete and separate meetings which may occur at different frequencies etc.

Equally an MRP system, which includes so-called MRP2 or MRPII systems, begin with material requirements planning allowing for the input of sales forecasts from sales and marketing. These forecasts determine the raw materials demand and manufacturing requirements based upon yields, timelines, etc. which are then merged with other sales forecasts for the same products or other products to yield a master production schedule. Accordingly, such systems allow the breakdown of specific plans for each product on a line allowing for coordination of raw materials purchasing, development of detailed production schedules that account for machine and labor capacity, as well as scheduling production runs according to the arrival of materials to yield a labor and machine schedule. Similarly, over time a variety of MRP systems have evolved, generally from physical implementations, into software implementations where scheduling is traditionally based on forecast “pushing” but more commonly today on demand “pull” with concepts such as lean manufacturing and Just-In-Time (JIT) manufacturing. Again, whilst there are a wide range of MRP software tools to help users to create, manage, and visualize their production operations, sales, logical dependencies etc. and organize workloads, staff etc. these tools stand independent of any tools for tracking meetings, actions given, action status etc. as discussed above nor providing users with a clear view of their actions arising from multiple projects with multiple discrete and separate meetings which may occur at different frequencies etc.

Typically, PMTs and MRP tools are disconnected and treated as independent software tools. However, the inventors have previously established a project planning and production tool that combines Gantt based visualization(s) and planning with Kanban production scheduling which is referred to within this patent specification as NEWTOOL. The fused PMT-MRP tool being described within World Patent Application PCT/CA2016/000018 entitled “Project and Resource Planning Methods and Systems” and U.S. patent application Ser. No. 15/545,361 entitled “Project and Resource Planning Methods and Systems,” the entire contents of which are incorporated herein by reference.

At present the tracking of actions for the vast majority of project meetings is undertaken through the use of templates within standard office productivity tools such as Microsoft™ Word and Microsoft™ Excel. These in common with dedicated meeting minute software and meeting software tools as noted supra stand independent of PMT and MRP tools.

Accordingly, it would be beneficial to provide users with a meeting management/action tracking software tool for tracking meetings, actions given, action status etc. as discussed above and providing users with a clear view of their actions arising from multiple projects with multiple discrete and separate meetings which may occur at different frequencies etc. It would be further beneficial for this meeting management/action tracking software tool to support interfaces with PMT, MRP, and combined PMT-MRP software tools such as NEWTOOL.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address project management and activity tracking and more particularly to methods and systems providing users with improved visualization and management interfaces for activity tracking, project meetings, and project management.

In accordance with an embodiment of the invention there is provided a method of associating a meeting relating to a project to a board relating to the project via a grid based graphical user interface.

In accordance with an embodiment of the invention there is provided a method graphical user interface comprising a grid comprising a plurality of rows and a plurality of columns; wherein
each row of the plurality of rows relates to a task associated with a project;
each first column of a plurality of first columns forming a first subset of the plurality of columns is associated with a characteristic of a task; and
each second column of a plurality of second columns forming a second subset of the plurality of columns is associated with a meeting relating to the project.

In accordance with an embodiment of the invention there is provided a method comprising:
establishing a project comprising a plurality of tasks; and
generating a visualization for the project for presentation to a user within a graphical user interface, the visualization comprising a grid having a plurality of rows and a plurality of columns; wherein
   each row of the plurality of rows relates to a task associated with a project;
   each first column of a plurality of first columns forming a first subset of the plurality of columns is associated with a characteristic of a task; and
   each second column of a plurality of second columns forming a second subset of the plurality of columns is associated with a meeting relating to the project.

In accordance with an embodiment of the invention there is provided a method comprising:
providing to a user associated with a project a board of a plurality of boards via a graphical user interface upon a display of an electronic device a grid based visualization, the grid based visualization being generated by project application in execution upon a remote server connected to the electronic device via a communications network and comprising a plurality of rows and a plurality of columns; wherein
each row of the plurality of rows relates to a task of a plurality of tasks associated with the project;
each first column of a plurality of first columns forming a first subset of the plurality of columns is associated with a characteristic associated with the plurality of tasks and an entry in a first column of the plurality of first columns within a predetermined row of the plurality of rows comprises first data relating to that characteristic for the task of the plurality of tasks associated with that predetermined row of the plurality of rows;
each second column of a plurality of second columns forming a second subset of the plurality of columns is associated with a meeting of a plurality of meetings relating to the project; and
an entry in a second column of the plurality of second columns within a predetermined row of the plurality of rows comprises second data relating to that meeting for the task of the plurality of tasks associated with that predetermined row of the plurality of rows.

In accordance with an embodiment of the invention there is provided a method comprising
providing to a user associated with a project a board of a plurality of boards via a graphical user interface upon a display of an electronic device a grid based visualization, the grid based visualization being generated by project application in execution upon a remote server connected to the electronic device via a communications network; wherein
the grid based visualization is established in dependence upon inputs made by the user via a user input interface of the electronic device;
the project comprises a plurality of tasks, each task having a status associated within as well as first data relating to the task, second data relating to timing information for the task, and third data relating to a status for the task;
a first predetermined region of the grid based visualization displays a first subset of the plurality of tasks in a vertical format, the first subset of the plurality of tasks established in dependence upon the second data of the plurality of tasks and one or more selections of the user made by the user via the user input interface of the electronic device as part of the inputs made by the user;
a second predetermined region of the grid based visualization relates to a timeline and displays a second subset of the plurality of tasks, the second subset of the plurality of tasks established in dependence upon the second data of the plurality of tasks and the timeline; and
the first predetermined region of the grid based visualization and the second predetermined region of the grid based visualization are displayed concurrently

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts examples of meeting templates according to the prior art;

FIG. 4 depicts an exemplary screenshot of a new planning visualization tool presented to a user according to an embodiment of the invention;

FIG. 5 depicts an exemplary screen layout of a new planning visualization tool presented to a user according to an embodiment of the invention;

FIG. 6 depicts an exemplary screen layout of a new planning visualization tool presented to a user according to an embodiment of the invention;

FIG. 7 depicts a dashboard presented to a user exploiting a project meeting and task tracking application (PMTTA) according to an embodiment of the invention;

FIG. 8 depicts a login access for a user exploiting a PMTTA according to an embodiment of the invention;

FIG. 9A depicts a full dashboard with tasks/projects and meetings by time within a graphical user interface (GUI) within a PMTTA according to an embodiment of the invention;

FIG. 9B depicts the ability for a user to scroll and view all meetings by time as well as select by board within a MRP-PMT system or project within a MRP-PMT irrespective of board association within a PMTTA according to an embodiment of the invention;

FIG. 10 depicts exemplary search interfaces and automatic zoom/adjustment based upon adjusting font/column width within a PMTTA according to an embodiment of the invention;

FIG. 11 depicts an ability for a user to open task details from within a PMTTA according to an embodiment of the invention;

FIG. 12 depicts an ability of a user to add messages/view threads etc. within a PMTTA according to an embodiment of the invention;

FIG. 13 depicts an ability to add flags in comments that are then linked to meeting notes within a PMTTA according to an embodiment of the invention;

FIG. 14 depicts an ability to flag notes as “To Do” with differential visual identification within a PMTTA according to an embodiment of the invention;

FIG. 15 depicts an ability for a user to move sequentially through tasks based upon task status within a PMTTA according to an embodiment of the invention;

FIG. 16 depicts an ability for a user to select task/change status within a PMTTA according to an embodiment of the invention thereby removing them from subsequent display together with ability to export the PMTTA data grid to third party applications; and

FIG. 17 depicts the ability of a user to create a sub-task and associate it with a note and handle it as a task within a PMTTA according to an embodiment of the invention.

### DETAILED DESCRIPTION

The present invention is directed to project management and activity tracking and more particularly to methods and systems providing users with improved visualization and management interfaces for activity tracking, project meetings, and project management.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by an ability to extract and process content presented and associate to defined actions etc.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” relates to miniature electronic devices that are worn by the user including those under, within, with or on top of clothing and are part of a broader general class of wearable technology which includes “wearable computers” which in contrast are directed to general or special purpose information technologies and media development.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request; said request may be a query, a search, a trigger, an alarm, and a message for example.

Reference to a “grid” as used herein may refer to, but is not limited to, any tabular, columnar, or other logical arrangement of data stored within a database as displayed to the user wherein a row, column, or other aspect of the grid relates to data having a common relationship within the database. For example, within a Microsoft™ Excel spreadsheet data may be presented as a grid which is a two-dimensional (2D) table with rows and columns.

Reference to a “database” as used herein may refer to, but is not limited to, any organized collection of data. A database may include, but not be limited to, a collection of schemas, tables, queries, reports, views and other objects. Generally, databases can be divided into data sources, data consumers, actionables, etc. More specifically, each database may have one or more large structured sets of persistent data. These structured sets of persistent data are usually termed data sources. A data source is thus a type of object for a database. Data consumers are other types of database objects; examples of data consumers are data processing objects, data formatting objects, data input objects, etc. Data sources actually store the data of a given database, and the data consuming object types provide some kind of view on or of the stored data. Example descriptions of the above-mentioned database object types are provided below. First, data sources are sets of like data that can be described by one schema. More specifically, a data source is usually a set of similar records. Second, data processing objects represent a search on stored data. More specifically, a data processing object is usually a set of rules for retrieving data from one or more data sources. Third, data formatting objects present data from a data source or a data processing object in a formatted fashion. More specifically, a data formatting object is usually a set of rules for formatting retrieved data. Fourth, data input objects provide a simplified mechanism for inputting data into at least one data source. More specifically, a data input object is usually a document or similar displayable file that provides a relatively quick and easy mechanism to modify and/or insert records into a database using an intuitive, graphical environment. Data input objects can also be used to filter and/or view data of a database.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “board” as used herein may refer to, but is not limited to, a visual representation that encapsulates a project or workflow. Within a traditional project management tool, a board is commonly referred to as a project or workspace.

Reference to a “list” or “lane” as used herein may refer to, but is not limited to, a set of related cards, which are typically those in the same stage of a process, within a titled column on a Kanban board, for example. Within a traditional project management tool, a list or lane is commonly referred to as a to-do list or task list.

Reference to a “card” as used herein may refer to, but is not limited to, an item related to a board and/or list such as a task to be completed or a product to be made and typically lives in a list on a board. Within a traditional project management tool, a card is commonly referred to a to-do or task.

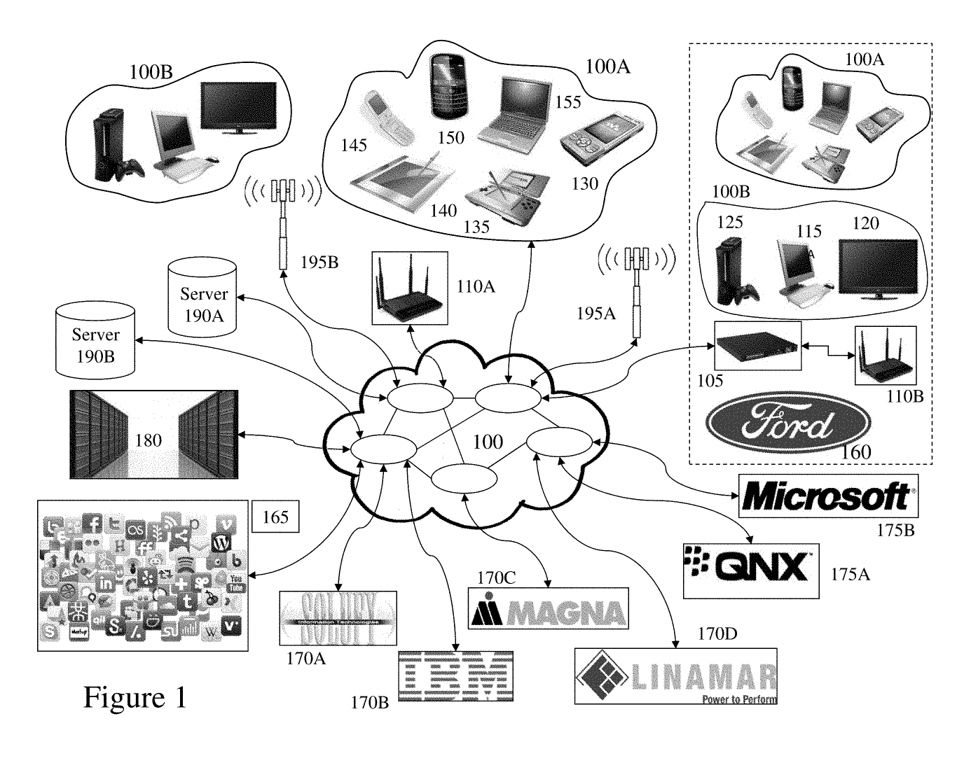

Referring to FIG. 1 there is depicted a network environment 100 within which embodiments of the invention may be employed supporting project meeting and task tracking applications/platforms (PMTTAPs) according to embodiments of the invention. Such PMTTAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Ford™, within which other first and second user groups 100A and 100B are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B which together with others, not shown for clarity. First and second servers 190A and 190B may host according to embodiments of the inventions multiple services associated with a provider of project meeting and task tracking applications/platforms(PMTTAPs); a provider of a SOCNET or Social Media (SOME) exploiting PMTTAP features; a provider of a SOCNET and/or SOME not exploiting PMTTAP features; a provider of services to PEDS and/or FEDS; a provider of one or more aspects of wired and/or wireless communications; an Enterprise 160 exploiting PMTTAP features; license databases; content databases; image databases; content libraries; customer databases; websites; and software applications for download to or access by FEDs and/or PEDs exploiting and/or hosting PMTTAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides PMTTAP features according to embodiments of the invention; execute an application already installed providing PMTTAP features; execute a web based application providing PMTTAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

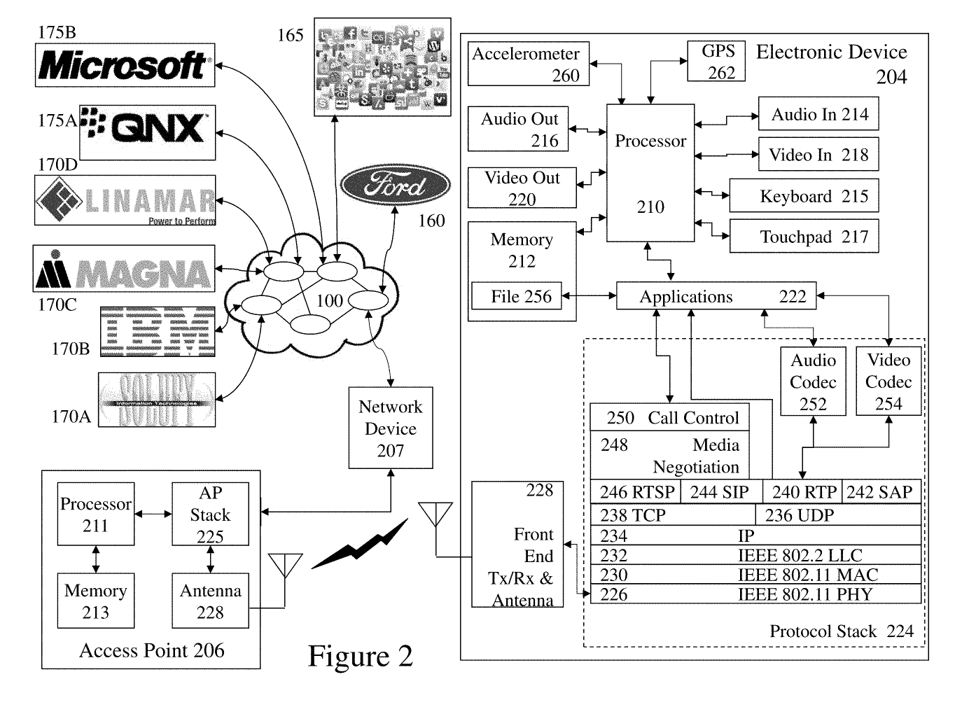

Now referring to FIG. 2 there is depicted an electronic device 204 and network access point 207 supporting PMTTAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 21, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, IMT-1000, DSL, Dial-Up, DOCSIS, Ethernet, G.hn, ISDN, MoCA, PON, and Power line communication (PLC).

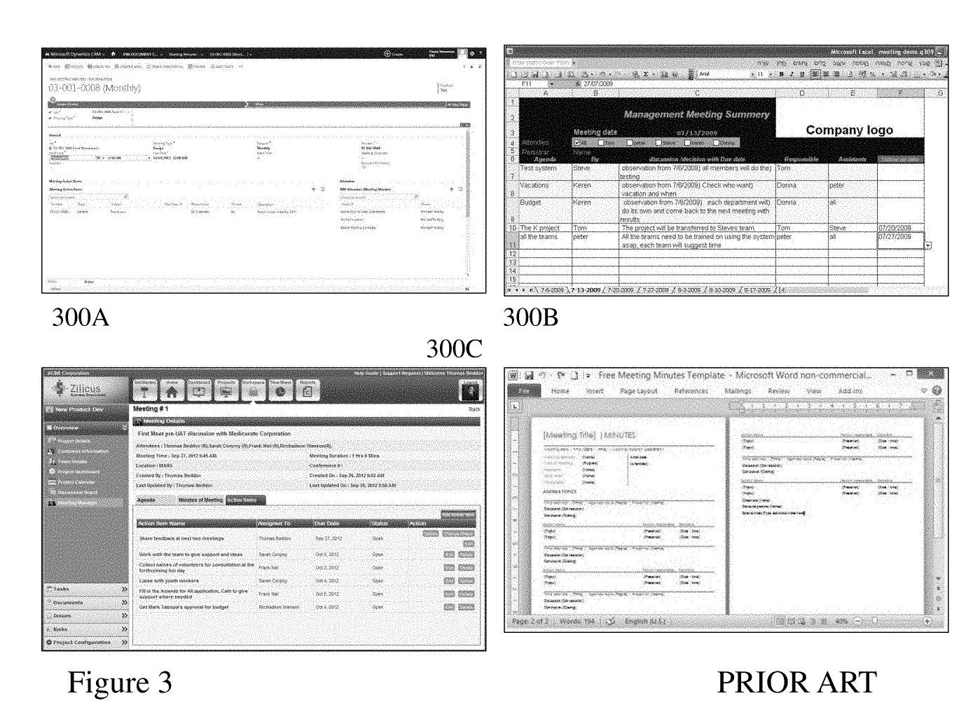

FIG. 3 depicts first and fourth images 300A to 300D respectively of prior art project meeting templates and software tools. First image 300A displays a meeting template within Microsoft™ Dynamics, a Customer Relationship Management (CRM) tool, representing a meeting template employed by a sales team within an enterprise. In contrast, second image 300B represents a custom template generated within Microsoft™ Excel (a spreadsheet) whilst fourth image 300D represents a custom templated generated within Microsoft™ Word. Third image 300C represents a commercial online software meeting tool, Zilicus™.

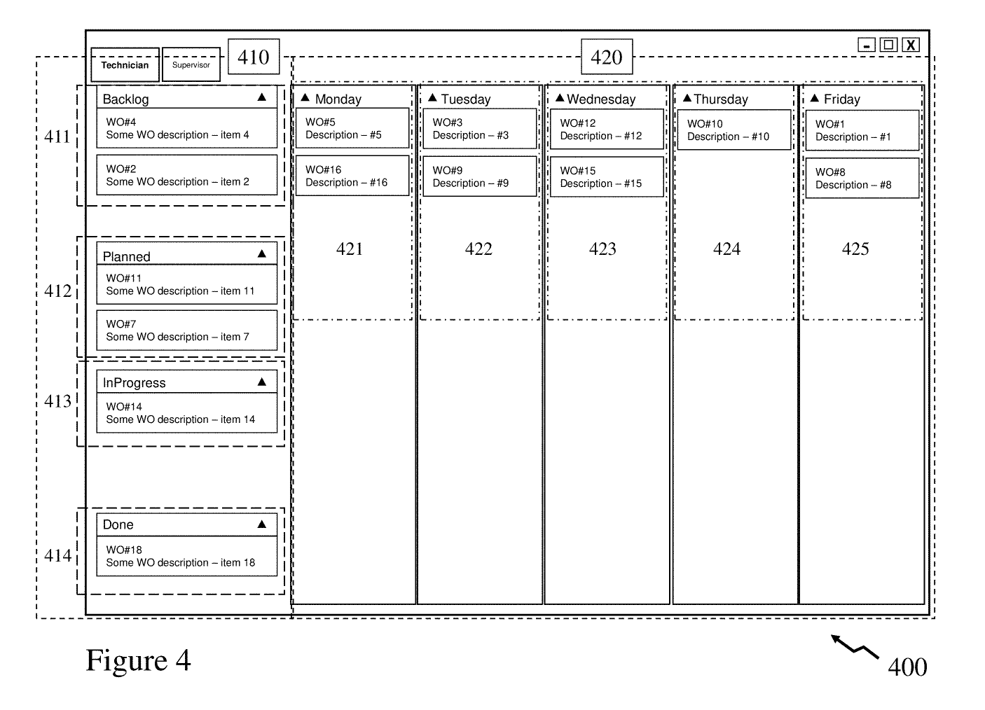

As noted supra the inventors have established a new visualization/planning tool combining MRP and PMT functionality, NEWTOOL, which adds the concept of timelines to elements of Kanban and adds the concepts of time and resource workload/availability to the Kanban concept. Referring to FIGS. 4 to 6 there are depicted exemplary screenshots of NEWTOOL according to which embodiments of the invention may be linked and which may display aspects of a PMTTA according to embodiments of the invention or wherein aspects of the NEWTOOL may be displayed within the PMTTA according to embodiments of the invention.

Accordingly, NEWTOOL provides a graphical user interface (GUI) which may provide for visual display which may be generated and populated based upon existing scheduling data coming from a source planning system such as an ERP, MRP, or project planner for example or generated from other databases, data sources etc. Accordingly, NEWTOOL may allow a user to interact with tasks such as move, drag, annotate etc. as well as address visualization of data from another PMT. It would be evident that NEWTOOL may be implemented as part of a software suite providing these other elements or that NEWTOOL may be the visualization engine/GUI for an existing planning suite. In a similar manner a PMTTA according to an embodiment of the invention may be a discrete software application, part of a software suite, a module for a software suite and/or application.

A status of a task may be interpolated through NEWTOOL to a Kanban status/column discretely or based upon a project tool and a time management/cost tracking tool. For example, a task may be identified in the plan as being due for work by the user in which case it is within their “To Do” or “Planned” columns for example, but once they add time data to a cost tracking tool or against the task through NEWTOOL then it proceeds to “In Progress” until the user indicates the task is complete e.g. has reached 100%, in which case it proceeds to “Done.” User data within a cost tracking tool may trigger a task into an “In Progress” but typically will not trigger a task into “Done” as the time actually associated by the user in completing the task may different above or below that assigned initially to the task.

Within the exemplary screenshots of FIGS. 4 to 6 the activities, also referred to as tasks or work orders (WOs) are generally populated in their associated column(s) based on their status or where they are in the workflow, or based on any other configurable variables. These activities may also appear in the associated timeline column(s) based on the schedule date(s) associated with them. For simplicity purposes, an activity can appear in either a column of the “workflow” area, or in a column of the timeline area. The “workflow” area is, for example, the set of “state” columns established with respect to the user's activities such as, for example, “Backlog”, “Planned”, “In-Progress”, and “Done”, whilst the timeline area may be a column or columns with weekday captions associated with them. As the timebase is varied “weekday” captions may shift to week identifiers, e.g. Week 5; monthly indicators; quarterly indicators; and yearly indicators.

Within the exemplary screenshots of FIGS. 4 to 6 an item (activity) may appear in both areas or may be associated with one or other area. Optionally, a first section of the GUI may show tasks/activities upon a first timebase, e.g. daily, whilst a second section may depict tasks within a second timebase as the user searches for example. An item may also have an aspect of its indication to the user varied in dependence upon it's associated state, e.g. its colour may be associated with its status such as pending, to do, in progress, and done, for example, whilst in other embodiments colour may indicate secondary status such as late, early, on-track, or critical, for example. Alternatively, the shape of a task's depiction may vary or alternatively other features such as highlighting, flashing, oscillating, etc. may be employed to highlight particular tasks to a user. Within embodiments of the invention special items such as action items may also appear within the timeline column(s) such as those, for example, present within the PMTTA associated with the user using NEWTOOL.

Referring to FIG. 4 there is depicted an exemplary screenshot 400 of a new planning tool's visualization for a user according to an embodiment of the invention. Within this exemplary screenshot 400 relating to a viewed presented to a technician, employee, etc. performing activities there are depicted first and second regions 410 and 420. First region 410 being a representation in vertical format of the Kanban columns such as “Backlog” 411; “Planned” 412; “InProgress” 413; and “Done” 414. Second region 420 depicts tasks to the user based upon timeline as depicted by a standard 5 day working week of columnar information in Monday to Friday 421 to 425 respectively. Within Monday 421, for example, there are depicted first and second tasks 431 and 432 relating to “WO#5—Some WO Description—item 5” and “WO#16—Some WO Description—item 16” respectively. Other days, similarly displaying the tasks associated within the timeline to these days.

Optionally, the first region 410 may be arranged in different configurations, either as standard or through user selection; including but not limited to:
at the top, the right or at the bottom area or a mixture thereof;
arranged horizontally, for example “Backlog” 411 “column” may be to the left of the “Planned” 412 “column”, etc.;
arranged both horizontally and vertically; for example “Backlog” 411 “column” on the left and the other columns vertically on the right.

Within the screenshot 400 the user can drag items/tasks (activities) in a variety of ways, including, but not limited to;
from a state to a day to schedule the work;
from 1 state to the other to change its status/state;
from 1 day to the other to change its scheduled date; and
from a day to a state to change the ‘status/state’ of the task

The tasks may be colour coded to illustrate the overall workload for a given day such that, for example, the header of the day column can be color code and/or the back colour of the item container area can be color coded accordingly. Optionally, the header of the day column can also display the overall workload versus available hours for that day. Where the timeline shifts to weeks, months, etc. then the overall workload versus available hours for the displayed period. Optionally, as the timeline changes from days to weeks/months/etc. then the tasks may change such that they are smaller, e.g. only including summary information, e.g. “WO#5”, or are grouped according to task type, grouped according to task status (e.g. pending, planned, in progress, etc.). Optionally, the user may be presented with a “magnifying glass” overlay so that whilst viewing a compressed timeline, e.g. month, they are able to scroll the timeline “under” the “magnifying glass” which is displayed upon an expanded timeline, e.g. weekly or daily.

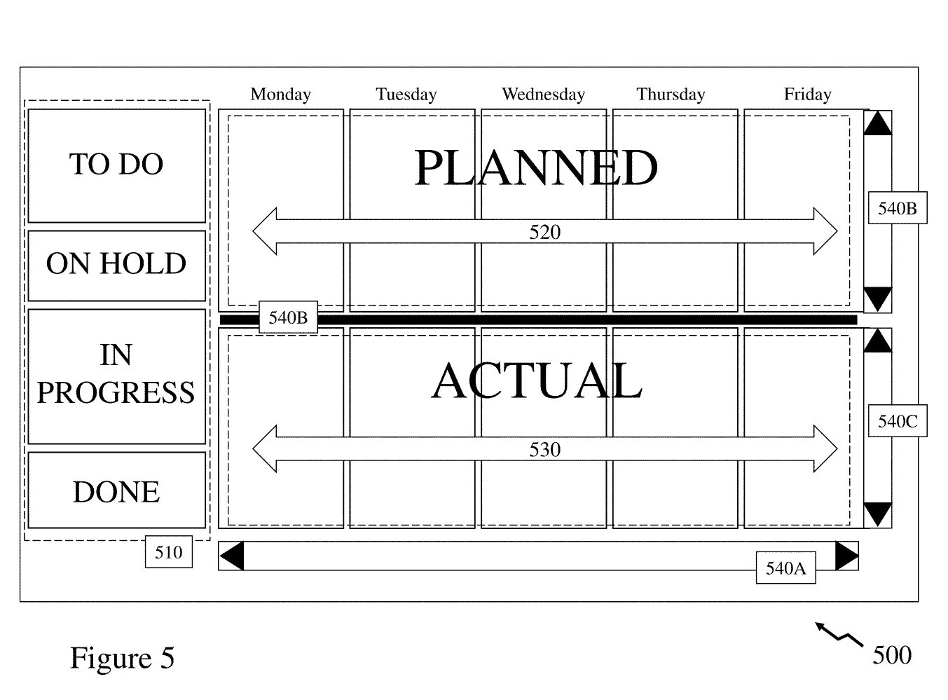

Now referring to FIG. 5 there is depicted an exemplary screenshot 500 of a new planning tool's visualization for a user according to an embodiment of the invention. Within screenshot 500 the NEWTOOL visualization relates to that viewed by a user, for example a resource or supervisor, for example, relating to displaying planned work versus actual work. Accordingly, as depicted the user is presented with first to third regions 510 to 530. First region 510 being in this instance a Kanban board representation in row format of their tasks. The rows presented may be configured by NEWTOOL, the resources supervisor, or by the resource themselves. For example, one resource may wish to only see “To Do” and “In Progress” whilst another may wish to view “On Hold”, “In Progress”, and “Done.”

Second region 520 depicts planned task for the resource over a timeline, in this instance a 5 day standard work week. Third region 530 depicts over the same timeline actual tasks. Through first to third scrollbars 540A to 540C allow for example:
First scrollbar 540A allows the user to scroll through the timeline;
Second scrollbar 540B allows the user to move vertically through all Kanban board stages or a subset of the Kanban board stages; and
Third scrollbar 540C allows the user to move vertically through all Kanban board stages or a subset of the Kanban board stages.

Accordingly, for example, using first and second scrollbars 540A and 540B the user can scroll through time and through “To Do”, “On Hold”, “In Progress” tasks or simply “In Progress” and “To Do” tasks whilst with first and third scrollbars 540A and 540C they can scroll through time and through “Done” tasks. Divider line 545 allows the user to adjust the relative sizing of second and third regions 520 and 530 respectively. Optionally, where multiple Kanban classes are displayed, e.g. “To Do”, “On Hold”, “In Progress” tasks within second window 520, additional divider lines may be selectable by the user to adjust their relative dimensions. Accordingly, the user may exploit the visual simplicity of prior art methodologies such as Kanban boards but within the context of timelines, task associations etc. that cannot be established and utilized within prior art Kanban methodologies.

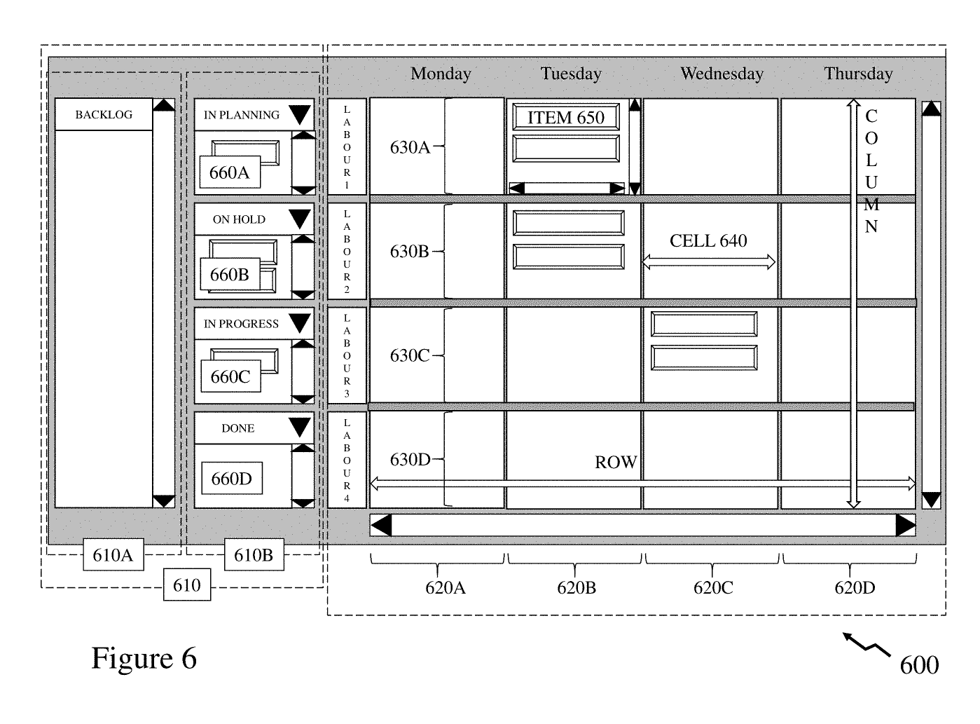

Now referring to FIG. 6 there is depicted an exemplary Display 600 of a new planning tool's visualization for a user according to an embodiment of the invention. Within display 600 the NEWTOOL visualization relates to a high level view of the GUI provided to users. Accordingly, Display 600 depicts/illustrates the different GUI components of our new control/visualization tool established by the inventor. These different GUI components being:
Display 600 is the entire client area of the GUI control;
Display 600 is divided into one or more Areas, e.g. first area 610 and second area 620, although the number of areas may be 1, 2, 3, 4 or more;
Each Area consists of one or more columns, e.g. first and second columns 610A and 610B respectively in first area 610 and first to fourth columns 620A to 620D respectively in second area 620, and 1 or more Rows, first to fourth Rows 630A to 630D respectively; although the number of columns/rows within an area may be 1, 2, 3, 4, etc. or equal numbers of rows/columns or unequal numbers of rows/columns;
The intersection of a column and a row is a Cell 640;
A Cell 640 can contain 1 or more Items 650; and
Each Item 650 can represent a work activity (task) or a non-work and may span across one or more columns of the timeline or appear across multiple rows when rows are associated with resources.

Each Area, Column and Row can be resized using a splitter between it and another element within the Display 600. Optionally, based upon the displayed timeline then an Item 650 may represent a grouping of items in order to reduce visual clutter/confounding. Each of these components can be scrolled vertically and/or horizontally as desired and as needed. As displayed in Display 600 first column 610A in first area 610 represents a column “Backlog” that spans multiple rows, e.g. “In Planning” 660A, “Planned” 660B, “In Progress” 660C, and “Done” 660D whilst depicted Items 650, whilst second column 610B in first area 610 has each row, e.g. “In Planning” 660A, “Planned” 660B, “In Progress” 660C, and “Done” 660D, delineated with Items 650. According to the content of each cell then these can be internally scrolled where the number of Items 650 exceeds the number displayed. Based upon the number of rows within an area relative to the number of rows displayed then these can similarly be scrolled. Based upon the number of rows within a non-timeline area relative to the number of columns displayed then these can similarly be scrolled. The columns within a timeline area may also be scrolled to progress forward/backward with respect to the time. In some instances, where the columns depicted represent the extent of a resources involvement with the project then this timeline scroll may be disabled, e.g. a resource that is a contractor.

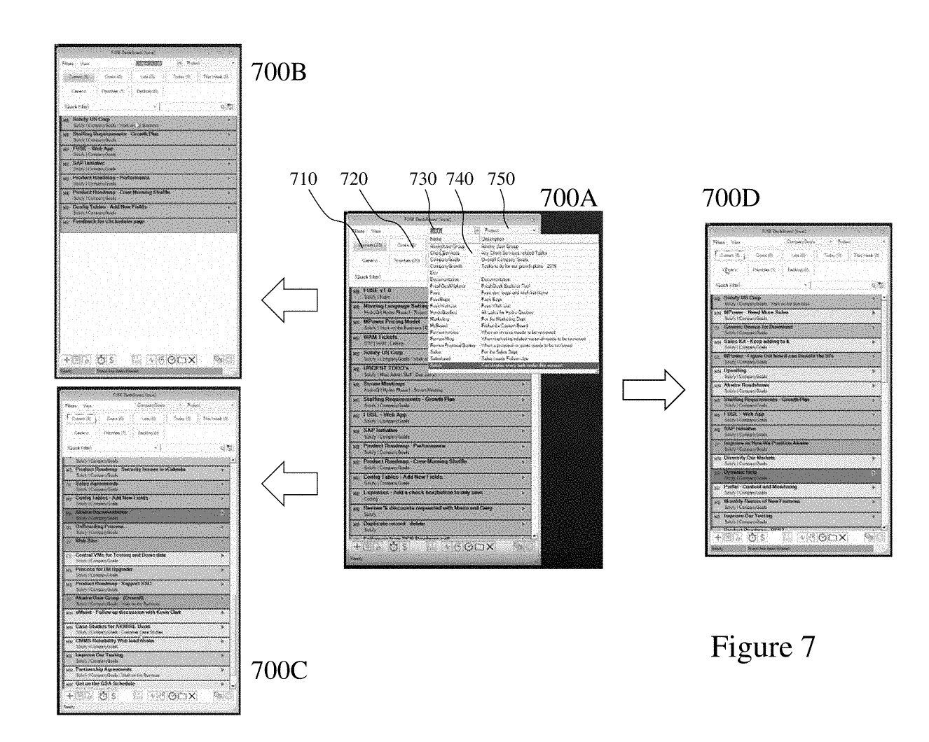

Now referring to FIG. 7 there are depicted first to fourth images 700A to 700D respectively of a dashboard presented to a user exploiting a PMTTA according to an embodiment of the invention. First image 700A depicts a quick access dashboard (QAD) for the PMTTA according to an embodiment of the invention presented to a user depicting only those tasks associated with the user wherein tasks with higher priority, e.g. those that are late, are displayed at the top followed by those with lower priorities. These are displayed with a title to the task, e.g. “FUSE v1.0” for the top-most task and a board to which the task relates, e.g. “Fuse” for the top most task. Accordingly, the tasks displayed may relate to multiple boards (projects) as in first image 700A or the user may filter for a single board and their tasks, such as depicted in second image 700B, or a single board and all tasks/users, such as depicted in third image 700C, or all boards and all tasks/users, such as depicted in fourth image 700D. These configurations being presented through selection of first Filter Button 710 “Current” of a plurality of Filter Buttons 720 which may provide options including, but not limited to, “Late”, “Today”, “This Week”, “Backlog” and “Priorities.” Each Filter Button 720 is either ON or OFF to apply the filter associated with it. These Filter Buttons 720 may be fixed in filtering applied or configurable and may be dynamically added based on the user's configuration settings/preferences allowing different users to have different filters. Optionally, Filter Buttons 720 may be dynamically added based upon the status of the board as a weekly or monthly filter option has no value or effect if only one meeting is entered or several over the space of a few days are added. Optionally, dynamic adjustment from daily/weekly filtering to weekly/monthly and then monthly/quarterly filtering may be applied. If multiple boards are open concurrently Filter Buttons 720 may be added for each board automatically or under user control.

Accordingly, a user through the QAD may access the PMTTA in its smallest and simplest dashboard format for tasks that are assigned to and/or owned by a user. As noted in respect of first to fourth images 700A to 700D these may range from those for a single board and the single user through to all tasks/goals associated with the enterprise, organization, facility, etc. The user can scroll through the actions where these extend beyond that displayable within the QAD. The QAD tasks may be coloured and/or patterned to differentiate one or more aspects such as, for example, board, user, etc. together with additional colouring/patterning and/or markers associated with priority or status for example. The user may in addition to exploiting tabs 720 exploit a first filter Category 730 such as enterprise, organization, facility, or team for example and filter by selecting a discrete board, a subset of all boards or all boards through second filter Project 750. As indicated selection of first filter Category 730 results in pop-up 740 listing the category names and their description. For example, considering a multi-national enterprise a user may be limited to viewing those of the facility they are employed at or those within their state/province (e.g. Texas, Illinois, California etc.), country (e.g. Canada, Japan, China, etc.), geographic region (e.g. North America, Europe, etc.), or all. Alternatively, the categories may be a product, product line, market sector, etc.

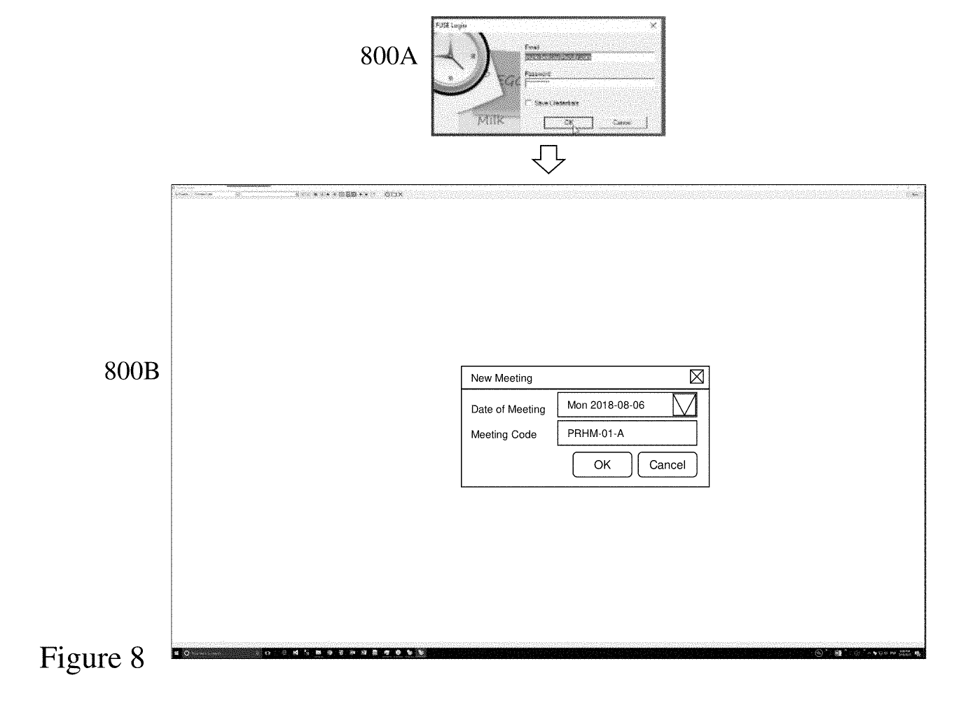

Referring to FIG. 8 a user may initially login to add a new meeting through a GUI 800A using a method as known in the art such as a credential, e.g. email address, username, etc. and a secret, e.g. password. A user's login may be preconfigured to a single board, a single facility, a single company, multiple boards (e.g. all research and development boards), multiple facilities, multiple enterprises, etc. Accordingly, user's may be provided access to boards based upon an aspect of the user such as position within the organization, role, etc. Once, the user's credentials have been validated and they have selected the board to which the meeting relates they are presented with GUI 800B wherein the user enters the date and time of the meeting.

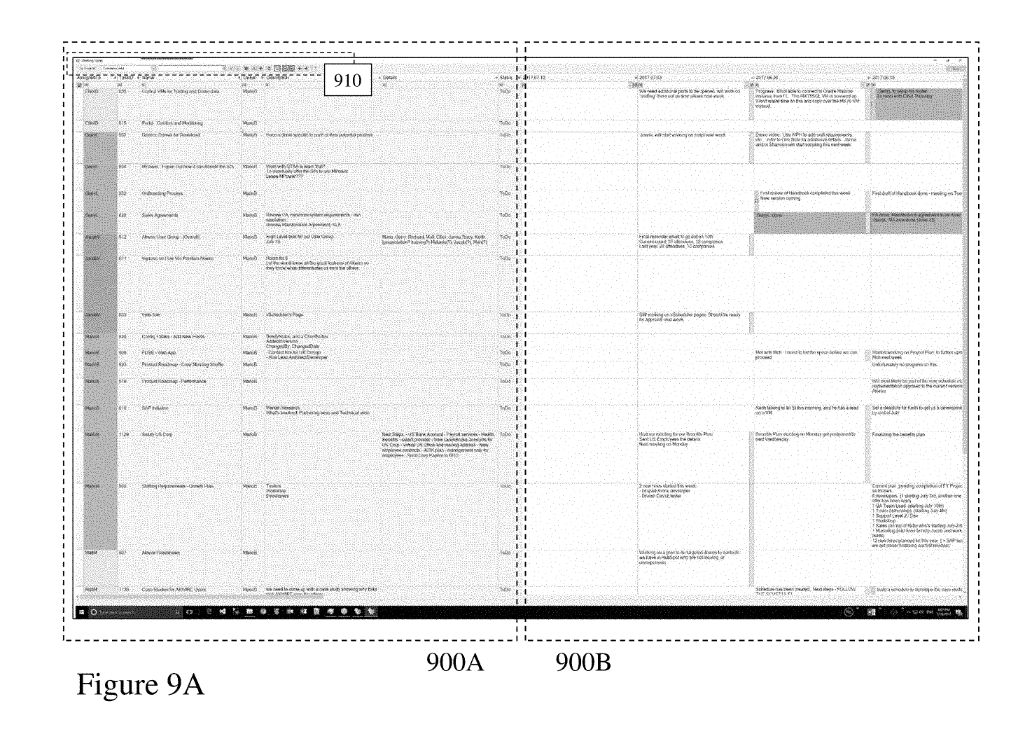

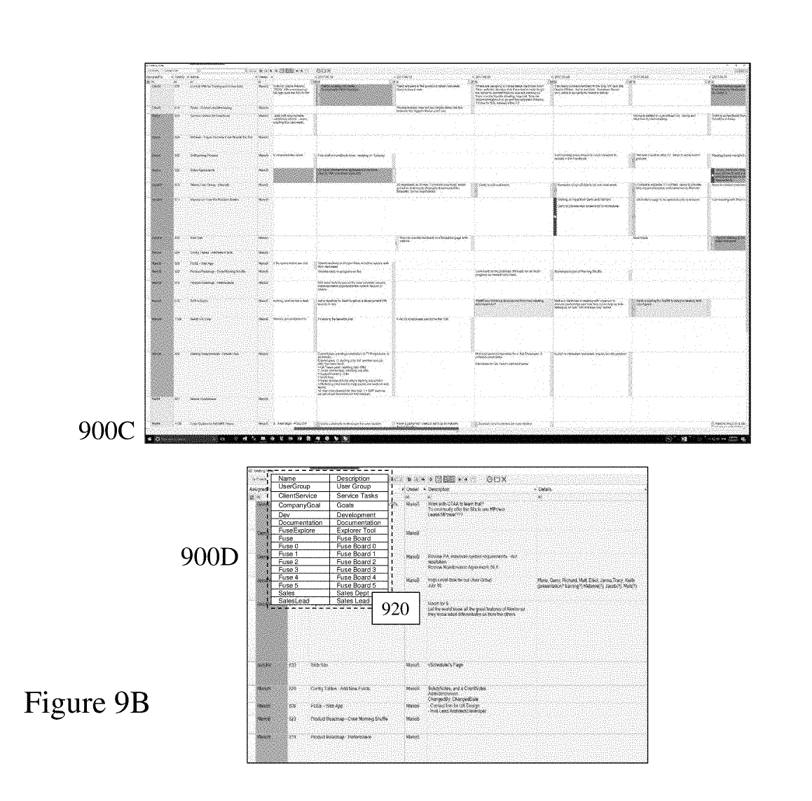

Accordingly, based upon the user entering the date and time of the meeting the PMTTA displays a GUI displaying first and second portions 900A and 900B as depicted in FIG. 9A. First portion 900A comprises all tasks with the specified board whilst second portion 900B comprises notes from all meetings for the specified board together with a new column relating to the new meeting. As depicted first portion 900A comprises a grid with each row relating to a task for the specified board and columns relating to aspects of the tasks including fields such as “Assigned To”, “TaskID”, “Name”, “Owner”, “Description” and “Details” for example. Second portion 900B displays a grid with each column relating to a different meeting. As depicted the first column is the current meeting, dated 07-10-2017, where no notes have yet been made whereas the next column relates to the last meeting 07-03-2017, the next to 06-26-2017 etc. Within the GUI depicted in FIG. 9A the tasks are sorted by the individual they are assigned to. Alternatively, the tasks may be sorted by other factors such as status, e.g. late/overdue, critical, etc. allowing the first items addressed within a meeting to be those most important to the board.

It would be evident that as the data is presented in chronological grid format that a discussion relating to a specific task can rapidly access the notes for each meeting since the task was added allowing its evolution and/or previous comments, decisions, notes etc. to be rapidly accessed. It would therefore be evident that the meeting has access to all previous meeting notes immediately for all currently pending tasks as within most embodiments of the invention assigning a task status to complete, closed, 100% etc. will result in the task not being displayed subsequently. However, should be it necessary to access closed/completed tasks then this can be undertaken through appropriate filter settings/options within the toolbar 910.

Referring to FIG. 9B first image 900C depicts the ability for a user to scroll and view all meetings by time as now the columns depicted relate to meetings between 05-22-2017 and 06-19-2017 rather than 06-19-2017 and 07-10-2017. Further, in second image 900D the user is able to rapidly access another board or project irrespective of the current board association through menu 920. Accordingly, the user is able to move to another project or board and enter notes immediately where an aspect of the current meeting touches upon the other project or board. Further, the association of notifications that are generated and distributed based upon a change or changes made to a board. For example, generation of a new meeting results in all associated with the board being notified that the meeting occurred and the notes are accessible whereas a change to a task within another board during a meeting for a board may be communicated to only the user or users associated with that task. Alternatively, the notifications may be made to only those users within the board for whom changes and/or entries were made within the meeting. The settings of such notifications being defined by one or more “owners” of the board when established or as modified during execution of the board.

Accordingly, it would be evident that entry of text within a cell or an adjustment of a characteristic of a cell within a row may trigger one or more notifications to a user or users associated with that task within the board. Further, as will be discussed below markers/flags associated with meeting notes for a specific task may be coded, for example, by colour, marker, pattern, etc. to reflect a priority level assigned to the task within the meeting or alternatively as defined by the board within the PMT-MRP where it is now important, overdue, critical, critical path etc. Accordingly, for example a meeting note “Waiting for input from Gerry and Richard” may be flagged high importance in respect of a task associated with “Jacob” that is not yet critical but will become so if that input is not provided.

Within an embodiment of the invention an “owner” of a board when assigning individuals to a board establishes an identity of the user and an associated electronic messaging address or addresses to which notifications will be sent. For example, a common format may be first name (or a name usually used by the user) and a first initial of their surname to avoid confusion. For example, “Jacob Bernstein” becomes “JacobB” and subsequently the PMTTA identifies instances of these identities being entered within the meeting notes or in the generation and assignment of a new task etc. so that notifications can be appropriately communicated.

Accordingly, in the example supra of “Waiting for input from Gerry and Richard” the PMTTA may flag these if the board format is FirstName+FirstSurnameInitial such that the user enters their identity appropriately thereby triggering the PMTTA matching these as now being associated with content within a note made within the meeting for that board and hence can send notifications to those users. If these users have no prior association to the board or other boards within the PMTTA database then the user may be prompted to generate their identities etc. Accordingly, even though “Gerry” had no prior association to the board he is notified that this is no longer the case and that he appears within the meeting notes (minutes). This notification may include information such as identity of board, date of meeting, task identity, who the task is associated with and the note from the meeting. It would be evident that within embodiments of the invention such a notification is the addition of a task to that user or users within the current board and/or their QAD. If the user is external to the organization controlling the board the notification might be by email only or alternatively the notification may allow the named individual restricted read only access to that row/meeting within the board.

It would be evident that a board or boards may contain a large number of tasks or that entries made may be quite detailed. Accordingly, a PMTTA according to embodiments of the invention provides users with tools allowing them to rapidly search/locate entries within the board or boards. For example, first image 1000A depicts the result of a “quick find” according to an embodiment of the invention wherein the GUI now starts filtering as the user types the search text within general search field 1010 and displays all entries where the search test is found whether it is within the task information, meeting notes, task notes, tasks, etc. such that time is not wasted scanning for the search text or tabbing through all occurrences to find the one the user wants or another in the meeting seeks.

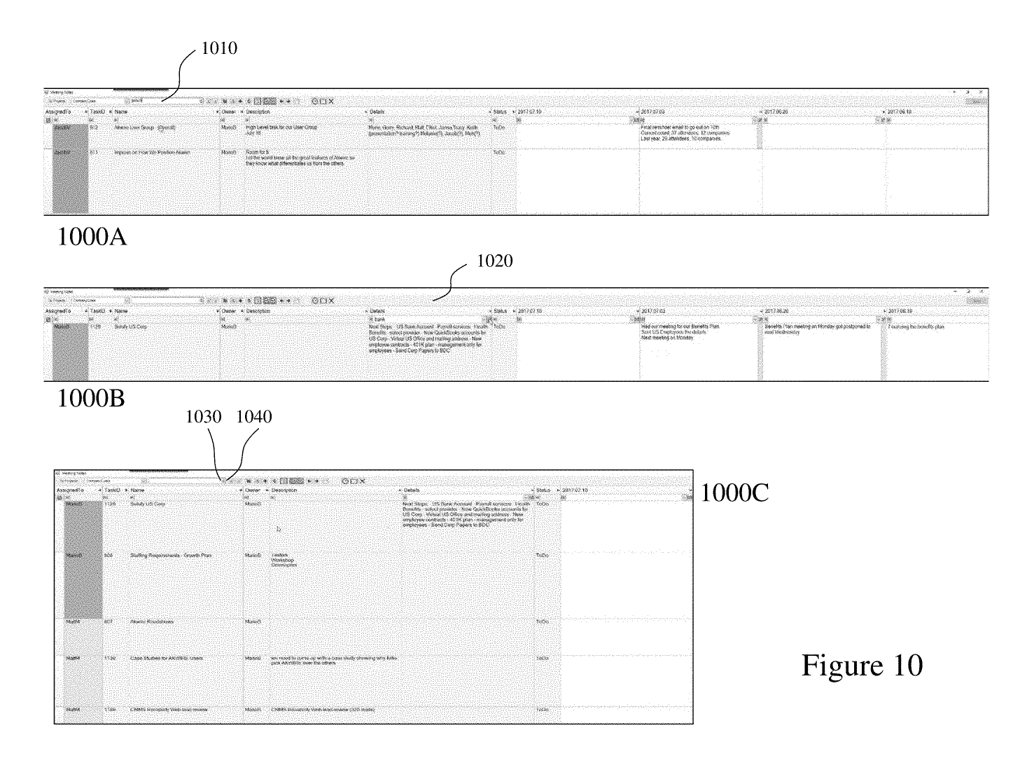

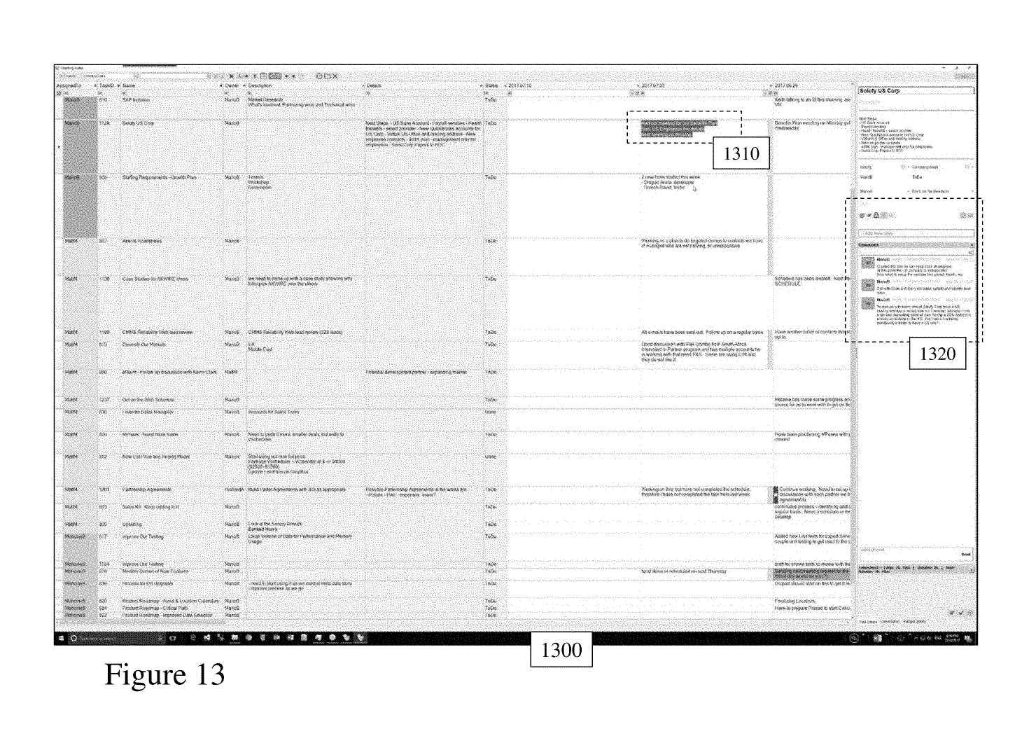

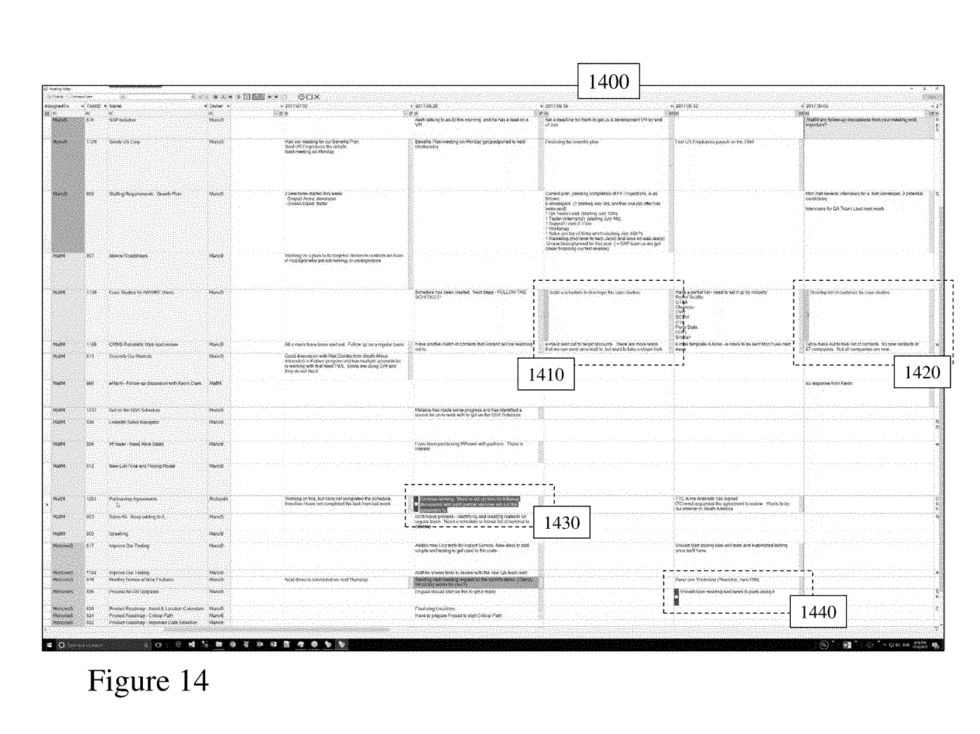

Similarly, if the user now selects an entry box 1020 below a specific column as depicted in second image 1000B in FIG. 10 then the same process is performed but now restricted to entries within that column. Similarly, a user can rapidly adjust the displayed board data within the PMTTA GUI as depicted in third image 100C in FIG. 10 by increasing/decreasing the font size through first and second buttons 1030 and 1040 within the toolbar of the PMTTA GUI. As these font adjustments are made the PMTTA automatically adjusts the data grid via column widths and/or row heights. Optionally, column width and/or row height may be locked through configuration settings so that whilst the font size adjusts the number of rows and/or columns is maintained or alternatively both may scale automatically. It would be evident that the data grid may allow the task related board content in the first portion, e.g. first portion 900A of FIG. 9, to be filtered through one or more filter presets such as “Summary” wherein only task name and description are depicted, “Short Form” wherein task name, description, assigned user, and task identity (Task ID) are depicted, or “Full” wherein all columns are depicted. Equally the second portion of the PMTTA GUI relating to the meetings may be filtered based upon a predetermined time duration, e.g. 1 month, 3 months, etc. or a number of meetings, e.g. last 2, last 4 etc. These may be combined with status filters such that, for example, critical and late tasks are addressed and then the meeting move to other tasks as appropriate. However, as a user may enter notes, add task, sub-task etc. independent of a meeting such as depicted below in respect of FIGS. 13 and 14 lower priority/non-critical tasks may be addressed separately allowing a meeting to focus to the important tasks and then the team returns to actually executing the tasks.

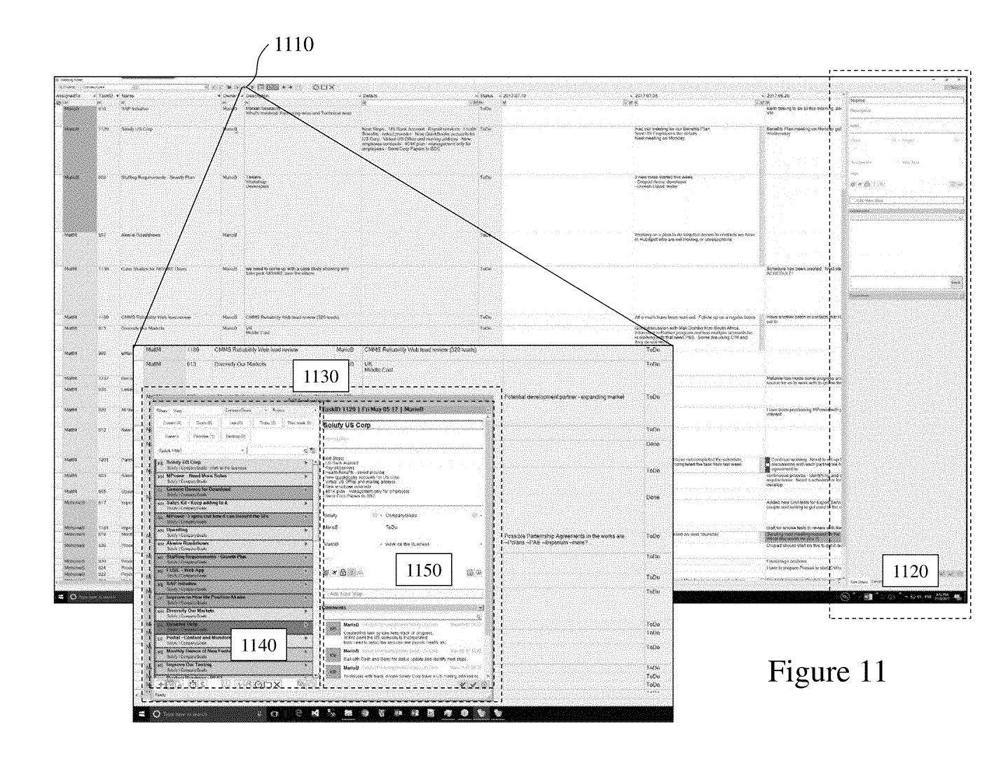

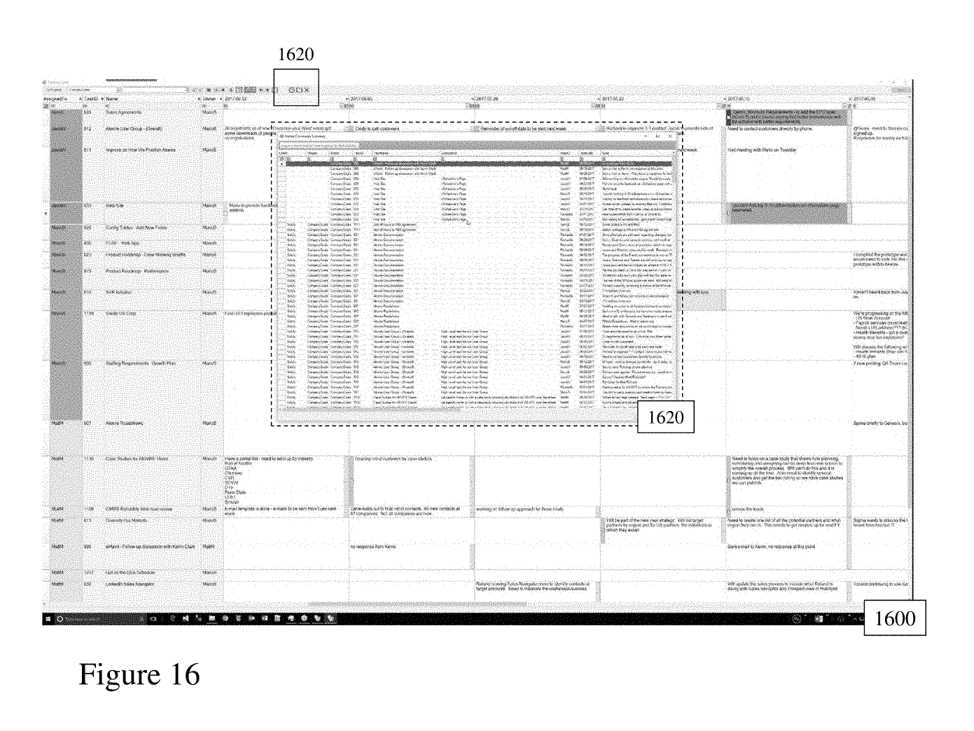

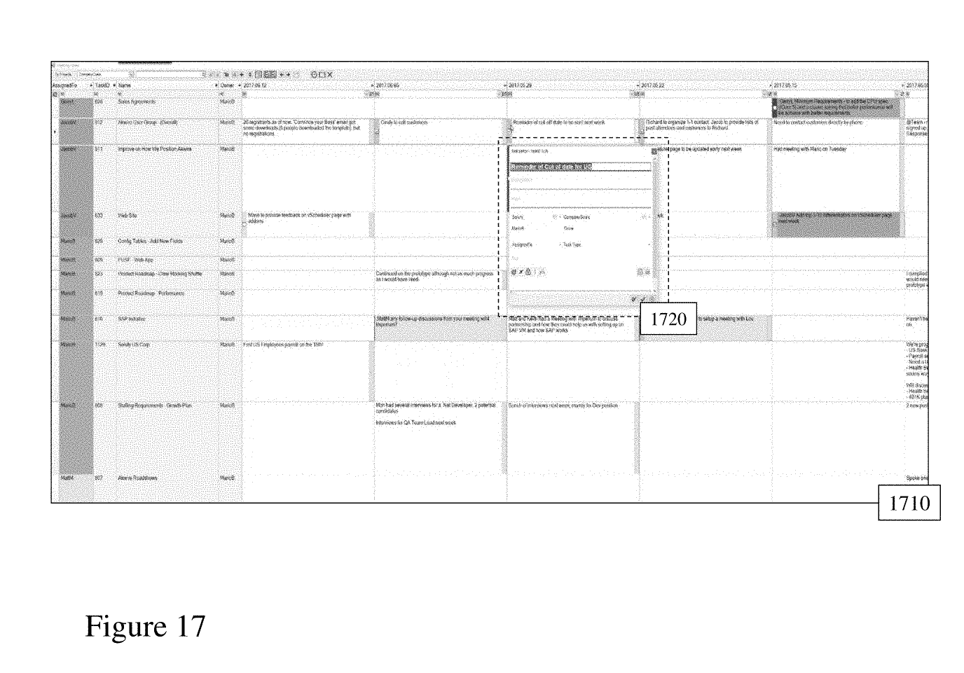

Now referring to FIG. 11 a user selects QAD icon 1110 within the PMTTA GUI 1120 according to an embodiment of the invention allowing the user to open task details from within the PMTTA. Selection of the QAD icon 1110 triggers the PMTTA to display a task details window. This may be, as depicted, modified QAD 1130 comprising a left window portion 1140, which is as described and depicted in FIG. 7, and a right window portion 1150 which depicts task details/information for the current task selected within the PMTTA GUI 1120. Optionally, selection of the QAD icon 1110 may trigger display of only left window portion 1140 or only the right window portion 1150. Right window portion 1150 may, for example, depict the task description, next steps identified, notes and comments (as discussed further below in respect of FIGS. 16 and 17 respectively). The right window portion 1150 may be similarly accessed from within the left window portion 1140 of the modified QAD 1130 either when triggered from the PMTTA GUI 1120 by selection of QAD icon 1110 or as displayed discretely as depicted in FIG. 7.

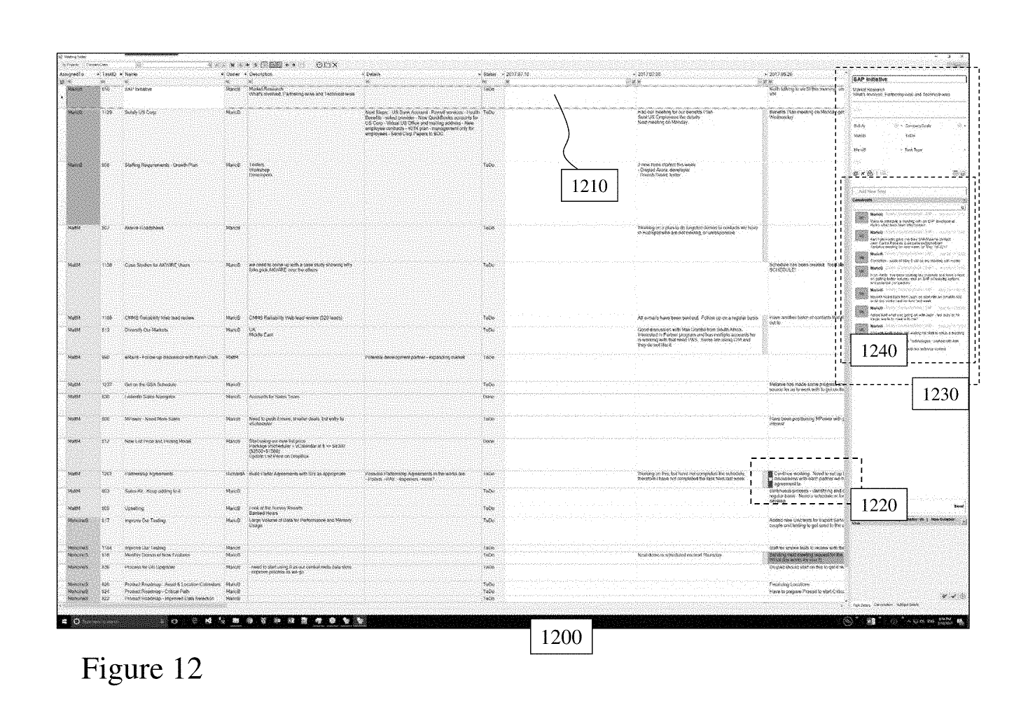

Now referring to FIGS. 12 and 13 there are depicted PMTTA GUIs 1200 and 1300 respectively according to embodiment of the invention allowing the user to exploit a “chat window.” In FIG. 12 the Chat Window 1240 is displayed in association with a task 1210 or meeting note 1220 through the task details window 1230. Accordingly, users accessing a board may post comments directly within the PMTTA with respect to a task and the meeting notes. Accordingly, the board within the PMTTA becomes a central knowledge base for the board and communication threads associated with it allowing users with access to the board to raise queries, obtain answers, review decisions, etc. Optionally, comments added by users within the board may also be posted to one or more SOCNETs/SOMEs allowing users to access the discussion when unable to access the PMTTA. Alternatively, within other embodiments of the invention the board may be linked to a SOCNET/SOME such that a user can post comments within the SOCNET/SOME that are then linked to the board within the PMTTA. In this manner, for example, a task may be associated with a specific client and product within the board and the customer may access only that communications thread but their comments are now embedded within the board allowing all users of that board to view the comment. In this manner potential communication issues between a customer impacting one or more of development/research/marketing/production are not impacted by the requirement to route these through a sales contact. Similarly, board data relating to completion of tasks, e.g. a production task, card, etc. can be posted directly to a SOCNET/SOME providing direct information to a customer, remote salesforce etc.

In FIG. 13 the PMTTA GUI 1300 has a note 1310 and associate comments window 1320. Within embodiments of the invention the meeting notes/comments may become “blended” and accordingly a flag may be set within the comments window 1320 in respect of a comment such that it is displayed within the meeting notes section. Alternatively, another flag may be set such that the meeting note is added to the comments, potentially together with an indicator that identifies it as being a meeting note rather than a comment in the thread. In this manner the posting of comments to a SOCNET/SOME may also include the meeting note(s) associated with that task or a subset of them. Accordingly, a flagged element may be copied and stored into both the meeting notes and comment sections separately.

Optionally, a board may include extender fields or classes so that where appropriate these portions of the board can be expanded to provide unidirectional and/or bidirectional linking to an external database and/or tool such as, for example, sales lead related information within a CRM tool which is retrieved via a Uniform Resource Locator (URL) or database link. This can then be extended within a dashboard so that online system details can be accessed. For example, a ticketing system relating to customer queries, product servicing etc. can be interfaced to the board so that a board relating to these activities can access real time information when the meeting is held. Optionally, when a meeting is held the retrieved value is “frozen” into the board history so that subsequently it is evident what the remote value(s)/data were rather than what they currently are. Optionally, a subsequent access to the board may display on the “frozen” value or the “frozen” value and a current value. Such systems can be extended into development tickets within a software development tool, such as JIRA Software by Atlassian (https://www.atlassian.com/software/jira?) for example. Optionally, such tools may be viewed online through the PMTTA via an embedded browser.

Optionally, the “flags” associated with notes made in respect of a meeting may be extended as depicted in FIG. 14 with GUI 1400 wherein notes may be “flagged” as “TO DO” for an individual or group and hence are identified differently within the GUI. For example, these may be colour coded to identify not only that they have been tagged but a priority of the “TO DO.” Accordingly, as depicted in GUI 1400 first and second flags 1410 and 1420 are “green” whilst third and fourth flags 1430 and 1440 are “red” implying high priority relative to “green” or intermediate flags such as “yellow” etc. Alternatively, “red”, “yellow”, “green” flags may be associated with late, soon to be late, and not late. Other schemes based upon alphanumeric identifiers, colours, patterns, etc. may be employed within embodiments of the invention. For example, a note may be flagged by a keystroke action, e.g. “CTRL+T” and selection of a priority from a pop-up menu.

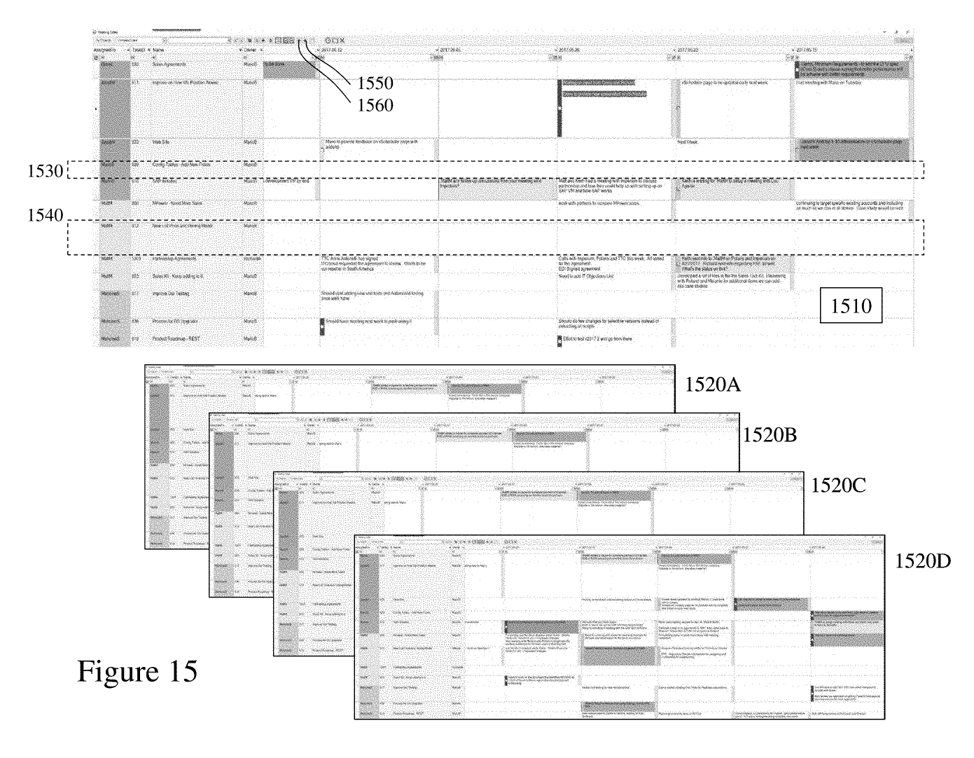

Accordingly, it would be evident that a new filter can be applied wherein only those tasks with a “TO DO” are displayed such as evident in first GUI 1510 in FIG. 15. As no time filter was applied, in addition to filtering to only display the tasks with associated “TO DO”s, then some “TO DO”s are associated with tasks in earlier meetings than the time window currently presents, e.g. first and second tasks 1530 and 1540. Optionally, additional filters may be applied to further filter or adjust the display according to priority.

Navigation from one “TO DO” to the next and its display may be achieved as depicted in in second to fifth GUI 1520A to 1520D, wherein as a user scrolls down by task then their view is automatically adjusted to include the flagged “TO DO” within the GUI. Alternatively, the user may simply navigate by selecting one of first and second Direction Buttons 1550 and 1560 respectively which allows the user to move sequentially to the previous or next task with a “TO DO.” In doing so, the displayed region of the right portion of the PMTTA similarly automatically adjusts so that the next “TO DO” task is within the visible portion.

Optionally, a new discrete GUI may be presented displaying each uncompleted task with a flagged “TO DO” adjacent and identification of the meeting. Such a display may be similarly by priority of flagged “TO DO” or oldest first etc. Accordingly, a user is able to filter in various manners to provide eased navigation and enhanced meeting efficiency.

Now referring to FIG. 16 there is depicted a GUI 1600 with a series of “quick” or “smart” buttons allowing a user to select a task and then change its status there and then within the GUI 1600. A task when its status is changed to “complete” or an equivalent term or its completion is indicated at 100% within other embodiments of the invention is not subsequently loaded at the next meeting or next time the board is opened unless a specific action is made to display all tasks. Optionally, the tasks may be displayed but the removal of these has been found to lead to improved meeting efficiency by the inventors. A user is also able within GUI 1600 through another quick button to display a pop-up window 1620 which is a simple data grid of all comments the user has added. This data grid can then be exported to a third party application. Optionally, this data grid may be filtered for all users, only the logged in user, a selected user, all tasks, all pending tasks, all completed tasks etc.

A user may also, as depicted in FIG. 17 with pop-up window 1720 within GUI 1710, create a sub-task and associate it with a note and handle it as a task within the PMTTA. Accordingly, the sub-task can be assigned, have a target date, a priority etc. and handled as if it was a task. Within this the user can also establish a series of steps so that a defined mechanism/sequence can be assigned to the user performing the task. Optionally, the series of steps are a series of tasks wherein completion of each leads to assignment of the next step. In this manner standard processes may be established and executed within the enterprise, organization etc. but only the current tasks are displayed. If considering this from the viewpoint of a Gantt chart then a sub-project is displayed either as a discrete line within the Gantt chart or all its elements are displayed. In this variant only the current active step (element) is displayed. Again the emphasis is on reducing extraneous content/information that does not directly impact/affect the meeting and discussions/logging of status etc. For example, displaying “test prototype” may be an obvious next step to the current task of “assemble prototype” and any discussion moot pending completion of the assembly. Accordingly, embodiments of the invention seek to reduce excess clutter when presenting information within a meeting or review context.

Within embodiments of the invention the user is presented with a data grid within the GUI for the board they are working on and accordingly their selection of a row within the grid automatically associates the note to that task rather than requiring attendees of a meeting or those getting the minutes to make an association (perhaps incorrectly) themselves.

Within embodiments of the invention coding has been described as being applied to identify tasks assigned to different individuals, However, within other embodiments of the invention, for example, in respect of “TO DO”s then the “TO DO” may be colour coded in respect of the individual/team for whom the “TO DO” (or a sub-task) is to be performed rather than the individual actually performing the “TO DO” or sub-task. Optionally, a “TO DO” for “Mario” to undertake may be colour coded as “Mario”, e.g. within an “Assigned To” cell for that task within the grid, as “Mario” has to do the “TO DO” for the task assigned to “Jacob.” However, the remainder of the cells for that task are still colour coded for “Jacob” as it is his task, i.e. “Mario” has the to do “Jacob's task.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing to a user associated with a project a board of a plurality of boards via a graphical user interface upon a display of an electronic device a grid based visualization, the grid based visualization being generated by project application in execution upon a remote server connected to the electronic device via a communications network and comprising a plurality of rows and a plurality of columns; wherein
each row of the plurality of rows relates to a task of a plurality of tasks associated with the project;
each first column of a plurality of first columns forming a first subset of the plurality of columns is associated with a characteristic associated with the plurality of tasks and an entry in a first column of the plurality of first columns within a predetermined row of the plurality of rows comprises first data relating to that characteristic for the task of the plurality of tasks associated with that predetermined row of the plurality of rows;
each second column of a plurality of second columns forming a second subset of the plurality of columns is associated with a meeting of a plurality of meetings relating to the project; and
an entry in a second column of the plurality of second columns within a predetermined row of the plurality of rows comprises second data relating to that meeting for the task of the plurality of tasks associated with that predetermined row of the plurality of rows.

2. The method according to claim 1, wherein
the plurality of second columns are displayed chronologically such that those meetings that were chronologically earlier are further from the plurality of first columns; and
the graphical user interface allows the user to sequentially move through the plurality of second columns.

3. The method according to claim 1, further comprising
receiving prior to providing the user associated with the project the board of the plurality of boards a plurality of inputs generated by the user via an input interface of the electronic device; and
establishing a new second column of the plurality of second columns within the board for a new meeting allowing notes associated with the new meeting to be entered, wherein
a first predetermined subset of the plurality of inputs relate to establishing the user as an authorised participant in the project;
a second predetermined subset of the plurality of inputs relate to establishing the board of the plurality of boards; and
a third predetermined subset of the plurality of inputs relate to establishing a time for the new meeting;

4. The method according to claim 1, further comprising
receiving a plurality of inputs generated by the user via an input interface of the electronic device relating to establishing a task sorting criterion to be applied to the plurality of tasks; wherein
the board of the plurality of boards displays the plurality of tasks as sorted in dependence upon the task sorting criteria.

5. The method according to claim 4, wherein
the task sorting criterion is a status of the task with respect to the project such that the plurality of tasks are displayed within the graphical user interface such that those currently impacting the project are presented first to a meeting relating to the project.

6. The method according to claim 1, further comprising
receiving from the user associated with the project a plurality of inputs generated by the user via an input interface of the electronic device;
updating the board of the plurality of boards in dependence upon the plurality of inputs generated by the user; and
automatically notifying all users associated with the project that the board of the plurality of boards has been updated; wherein
the plurality of inputs relate to establishing a new second column of the plurality of second columns within the board for a new meeting and entering notes associated with the new meeting; and
the notification to each user is an electronic communication generated and sent by the remote server.

7. The method according to claim 1, further comprising
receiving from the user associated with the project a plurality of inputs generated by the user via an input interface of the electronic device;
updating a task of the plurality of tasks associated with the board of the plurality of boards in dependence upon the plurality of inputs generated by the user; and
automatically notifying a predetermined subset of a plurality of users associated with the project, wherein
updating a task of the plurality of tasks comprises at least one of modifying the characteristic associated with a first column of the plurality of first columns for that task of the plurality of tasks and entering data in a new second column of the plurality of second columns associated with a current meeting relating to the project for that task of the plurality of tasks;
the notification to each user of the predetermined subset of the plurality of users is an electronic communication generated and sent by the remote server; and
the predetermined subset of the plurality of users associated with the project is established in dependence upon those users associated with the task of the plurality of tasks updated.

8. The method according to claim 1, further comprising
receiving from the user one or more second inputs generated by the user via the input interface of the electronic device, the one or more second inputs relating to the selection of a cell within the grid based visualization and a selection within a toolbar forming part of the graphical user interface associated with the project application relating to a quick access dashboard;
generating a second window within the graphical user interface, the second window displayed in a predetermined position of the graphical user interface with respect to the board of the plurality of boards and comprising data relating to the board of the plurality of boards; wherein
a first selection within the toolbar relates to a first quick access dashboard comprising only those tasks associated with the user; and
a second selection within the toolbar relates to a second quick access dashboard comprising a description, next steps, and comments of the task associated with the selected cell.

9. The method according to claim 1, further comprising
receiving from the user one or more second inputs generated by the user via the input interface of the electronic device, the one or more second inputs relating to the selection of a cell within the grid based visualization and the addition of a comment relating to the task associated with the selected cell;
associating with the remote server the added comment to at least one of a social network and a social media associated with at least one of the board of the plurality of boards and the project; wherein
a predetermined portion of the at least one of the board of the plurality of boards and the project are associated with a specific client of an organization to which the user belongs;
the at least one of the social network and the social media associated with at least one of the board of the plurality of boards and the project is accessible to the client.

10. The method according to claim 9, wherein
comments posted by the client within the at least one of the social network and the social media are automatically added to the predetermined portion of the at least one of the board of the plurality of boards and the project are associated with a specific client without the client having access credentials to the project application.

11. The method according to claim 1, wherein
a first portion of the board of the plurality of boards comprises a plurality of notes associated with the plurality of tasks;
a second portion of the board of the plurality of boards comprises a plurality of comments associated with the plurality of tasks; wherein
a first subset of the plurality of notes have a first flag associated with them such that they are displayed in association with the plurality of comments when these are displayed as part of the graphical user interface; and
a second subset of the plurality of comments have a second flag associated with them such that they are displayed in association with the plurality of notes when these are displayed as part of the graphical user interface.

12. The method according to claim 1, wherein
the board of the plurality of boards comprises at least one extender field of a plurality of extender fields, each extender field when selected allowing a predetermined portion of the board of the plurality of boards to be expanded and populated with data accessed by at least one of a unidirectional and a bidirectional linking to an external database.

13. The method according to claim 12, wherein
the at least one of the unidirectional and the bidirectional linking to the external database triggered upon selection of the at least one extender field of the plurality of extender fields accesses real time data in the external database to populate the expanded predetermined portion of the board of the plurality of boards; and
the retrieved data is entered into a board history such that the retrieved real time data is frozen within the board of the plurality of boards when subsequently retrieved.

14. The method according to claim 12, wherein
the at least one of the unidirectional and the bidirectional linking to the external database triggered upon selection of the at least one extender field of the plurality of extender fields accesses real time data in the external database to populate the expanded predetermined portion of the board of the plurality of boards; and
the retrieved data is stored into a board history such that the retrieved real time data is frozen within the board of the plurality of boards, wherein
a subsequent selection of the extender field results in both the previously stored frozen retrieved real time data and the current retrieved real time data being displayed within the graphical user interface.

15. The method according to claim 1, further comprising
receiving from the user one or more second inputs generated by the user via the input interface of the electronic device, the one or more second inputs relating to the establishment of a filter associated with a status of actions established within the plurality of second columns; and
displaying all actions associated with the user within the plurality of second columns of at least one of the board of the plurality of boards and the plurality of boards having a status matching the filter established by the user, wherein
the actions are displayed for all second columns of the plurality of second columns rather than a current subset of the plurality of second columns displayed to the user.

16. The method according to claim 1, further comprising
receiving from the user second inputs generated by the user via the input interface of the electronic device, the second inputs relate to one or more of the selection of a cell within the grid based utilization, the creation of a sub-task associated with the task to which the selected cell relates, and associating a note with the sub-task; wherein
the sub-task once created is handled by the project application as a new task.

17. The method according to claim 1, further comprising
automatically filtering the plurality of tasks associated with the board of the plurality of boards such that only those tasks within the plurality of tasks that are currently pending completion are presented within the graphical user interface.

18. A method comprising
providing to a user associated with a project a board of a plurality of boards via a graphical user interface upon a display of an electronic device a grid based visualization, the grid based visualization being generated by project application in execution upon a remote server connected to the electronic device via a communications network; wherein
the grid based visualization is established in dependence upon inputs made by the user via a user input interface of the electronic device;
the project comprises a plurality of tasks, each task having a status associated within as well as first data relating to the task, second data relating to timing information for the task, and third data relating to a status for the task;
a first predetermined region of the grid based visualization displays a first subset of the plurality of tasks in a vertical format, the first subset of the plurality of tasks established in dependence upon the second data of the plurality of tasks and one or more selections of the user made by the user via the user input interface of the electronic device as part of the inputs made by the user;
a second predetermined region of the grid based visualization relates to a timeline and displays a second subset of the plurality of tasks, the second subset of the plurality of tasks established in dependence upon the second data of the plurality of tasks and the timeline; and
the first predetermined region of the grid based visualization and the second predetermined region of the grid based visualization are displayed concurrently.

19. The method according to claim 18, wherein
the first predetermined region of the grid based visualization is a Kanban based representation of the first predetermined subset of the plurality of tasks; and
the second predetermined region of the grid based visualization is a Gantt based representation of the first predetermined subset of the plurality of tasks.

20. The method according to claim 18, wherein
the second predetermined region of the grid based visualization comprises:
a first region that displays that portion of the second subset of the plurality of tasks for which the third data indicates the task is planned; and
a second region that displays that portion of the second subset of the plurality of tasks for which the third data indicates the task is complete.
